(19) United States
(12) Patent Application Publication
(10) Pub. No.: US 2024/0332564 A1
(43) Pub. Date: Oct. 3, 2024

(54) HUMIDIFIER

(71) Applicant: AISIN CORPORATION, Kariya (JP)

(72) Inventor: Katsuhiro KAJIO, Kariya-shi (JP)

(73) Assignee: AISIN CORPORATION, Kariya (JP)

(21) Appl. No.: 18/595,618

(22) Filed: Mar. 5, 2024

(30) Foreign Application Priority Data
Mar. 28, 2023 (JP) 2023-051359

(51) Int. Cl. H01M 8/04119

(52) U.S. Cl. CPC H01M 8/04126

(57) ABSTRACT

A humidifier includes a humidification unit providing, for dry air, moisture of moisture-containing air sent from a fuel cell battery, and supplying humidified air to the fuel cell battery, a dry side flow path guiding dry air to the humidification unit, a dehumidified side flow path guiding dehumidified air to the humidification unit, a case accommodating the humidification unit, a bypass flow path connecting the dry side flow path to the dehumidified side flow path, and a switching valve switching dry air flowing through the dry side flow path, to one of the humidification unit and the bypass flow path. A part of the bypass flow path is provided at the case.

### CROSS REFERENCE TO RELATED APPLICATIONS

This application is based on and claims priority under 35 U.S.C. § 119 to Japanese Patent Application 2023-051359, filed on Mar. 28, 2023, the entire content of which is incorporated herein by reference.

### TECHNICAL FIELD

This disclosure generally relates to a humidifier that humidifies air to be supplied to a cathode side in a fuel cell battery.

### BACKGROUND DISCUSSION

JP2022-152019A (Reference 1) discloses a fuel cell battery system including a fuel cell stack that generates electric power by being supplied with hydrogen as a fuel gas and air as an oxidizing gas.

The fuel cell battery system of Reference 1 is configured in such a way as to be mountable on a vehicle, and air is humidified by a humidifier and then supplied to the fuel cell stack. The humidifier functions in such a way as to provide, for (exchange, with) dry air supplied from outside, moisture and heat contained in a cathode off-gas (air after reaction) discharged from the fuel cell stack.

Reference 1 describes an air bypass flow path that causes air to flow between an air supply flow path that supplies air to the humidifier and an air discharge path that discharges air from the humidifier.

The air bypass flow path described in Reference 1 discharges air flowing in the air supply flow path to the air discharge path at a time of stopping electric power generation of the fuel cell battery, and thus stops supply of air to the fuel cell battery, thereby functioning in such a way as to stop wasteful electric power generation.

However, the air bypass flow path described in Reference 1 is arranged in a place relatively separated from the humidifier, and for this reason, a conduit is necessary for causing a pair of the flow paths to communicate with each other, and an on-off valve is necessary for controlling an air flow in this conduit, thus causing an increase in size, an increase in the number of components, and concern about deterioration in routing of the piping.

A need thus exists for a humidifier, which is not susceptible to the drawback mentioned above.

### SUMMARY

A humidifier according to an aspect of this disclosure includes a humidification unit, a dry side flow path, a dehumidified side flow path, a case, a bypass flow path, and a switching valve. The humidification unit provides, for dry air to be supplied to a fuel cell battery, moisture of moisture-containing air sent out from the fuel cell battery. The dry side flow path is connected to the humidification unit. The dry air flows through the dry side flow path. The dehumidified side flow path is connected to the humidification unit. Dehumidified air generated by dehumidifying the moisture-containing air by the humidification unit flows through the dehumidified side flow path. The case accommodates the humidification unit, and includes an inflow port into which the dry air flows and an outflow port from which the dehumidified air flows out. The bypass flow path connects the dry side flow path to the dehumidified side flow path. The switching valve can switch the dry air flowing through the dry side flow path, to one of the humidification unit and the bypass flow path. A part of the bypass flow path is provided at the case.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a diagram schematically illustrating gas flow paths between a fuel cell battery and a humidifier;

FIG. 2 is a front view of the humidifier;

FIG. 3 is a plan view of the humidifier;

FIG. 4 is a cross-sectional view illustrating a case body and a bypass flow path of the humidifier;

FIG. 5 is a cross-sectional view of a lower portion of the case body of the humidifier;

FIG. 6 is a diagram schematically illustrating gas flow paths of an alternative embodiment (a);

FIG. 7 is a diagram schematically illustrating gas flow paths of an alternative embodiment (b); and

FIG. 8 is a diagram schematically illustrating gas flow paths of an alternative embodiment (c).

### DETAILED DESCRIPTION

The following describes embodiments of this disclosure, with reference to the drawings.

### [Basic Configuration]

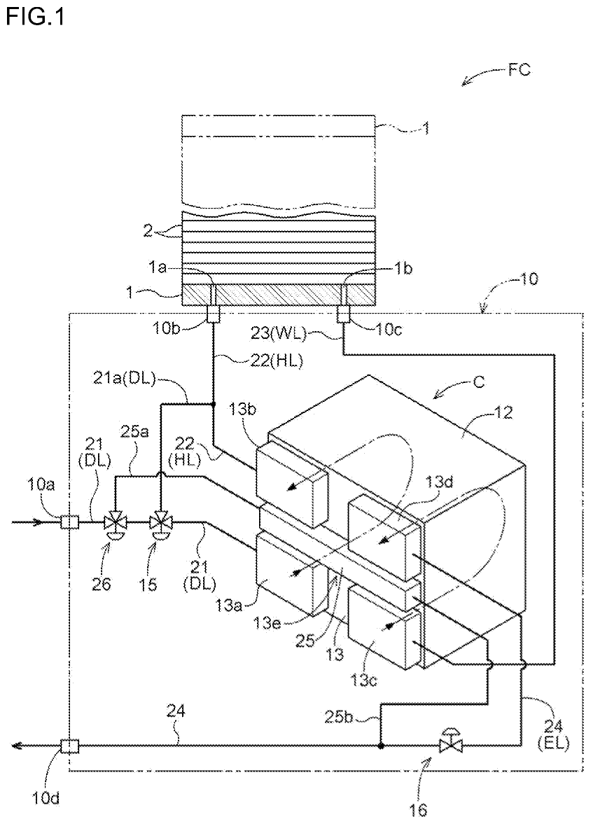

As illustrated in FIG. 1, a fuel cell battery FC is configured in such a way as to include two end plates 1 and a plurality of fuel cells 2 sandwiched between these end plates 1. This fuel cell battery FC includes a humidifier 10 at an outer surface of the one end plate 1. This fuel cell battery FC is one that is mounted on a fuel cell vehicle (FCV).

Although not illustrated in the drawings, a hydrogen supply unit is provided, and supplies a hydrogen gas (anode gas) to an outer surface of the end plate 1 that is out of the two end plates 1 of the fuel cell battery FC and that is on an opposite side of the surface at which the humidifier 10 is arranged.

As illustrated in FIG. 1, the one end plate 1 is formed with a suction hole 1a through which air (cathode gas) is supplied and a discharge hole 1b through which air (cathode off-gas) after reaction is discharged. The other end plate 1 is formed with a supply hole (not illustrated) for a hydrogen gas (anode gas) and a discharge hole (not illustrated) for a gas after reaction (anode off-gas).

In the fuel cell battery FC, a hydrogen gas (anode gas) from the hydrogen supply unit is supplied to an anode side in a plurality of the fuel cells 2, and humidified air (cathode gas) humidified by the humidifier 10 is supplied to a cathode side in a plurality of the fuel cells 2, and thereby, electric power is generated.

Electric power generation performance of the fuel cells 2 can be enhanced by maintaining, in a moderately moist state, a polymer electrolyte membrane that constitutes a cathode electrode. For this reason, the fuel cell battery FC is provided with the humidifier 10 for supplying humidified air to a cathode side in the fuel cells 2.

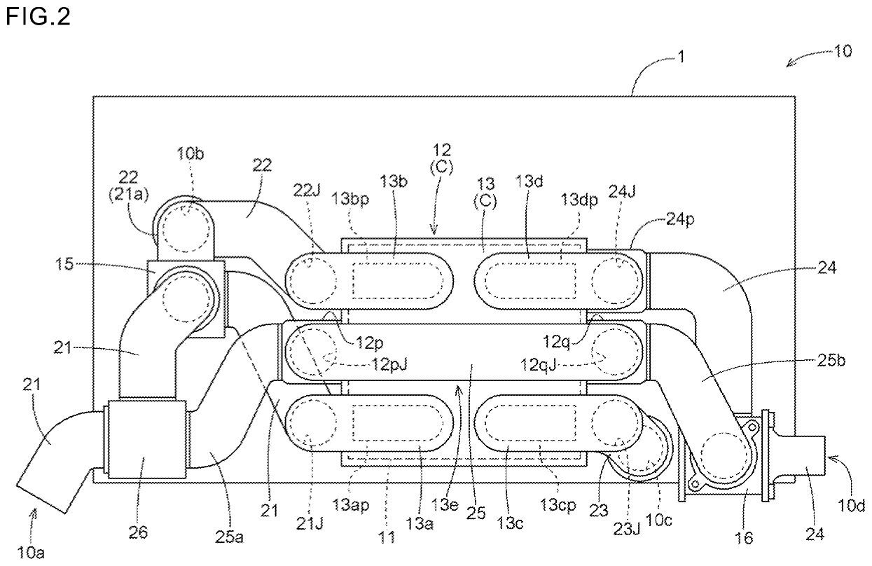

In the fuel cell battery FC, water generated accompanying the electric power generation is discharged in a state of being contained in air (a cathode off-gas which is referred to also as moisture-containing air in some cases in the following) after reaction. As illustrated in FIG. 2 to FIG. 5, the humidifier 10 extracts, by a humidification unit 11, moisture contained in the moisture-containing air, and humidifies air (a cathode gas, i.e., dry air) with the thus-extracted moisture, thereby generating the humidified air.

Particularly, the electric power generation in the fuel cells 2 is exothermic reaction, and for this reason, a temperature of the moisture-containing air rises. Thus, a temperature of the humidified air can be raised by providing, to the dry air, the moisture contained in the moisture-containing air, in the humidifier 10.

### [Humidifier]

In this embodiment, the end plate 1 is provided in a vertical orientation, and the humidifier 10 is provided on the outer surface of the end plate 1.

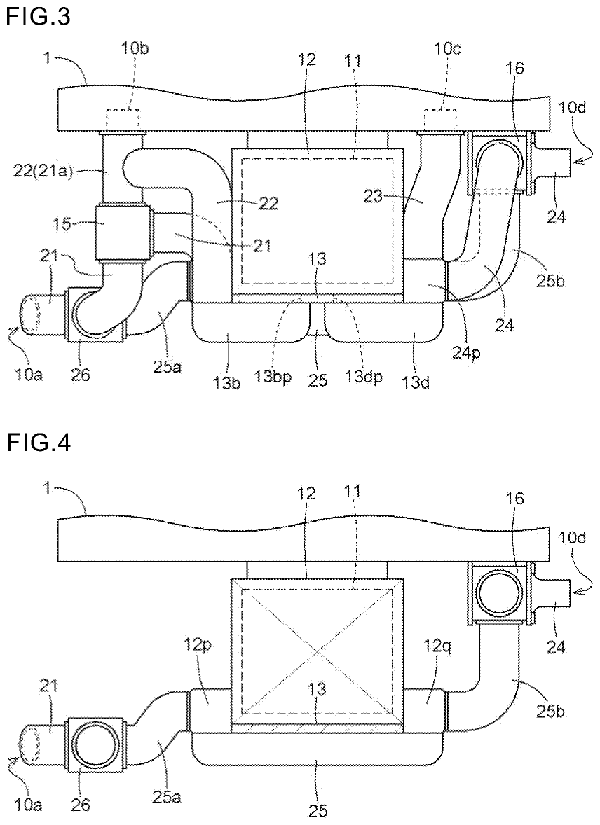

The right side in FIG. 2 and FIG. 3 is defined as a right side (a right portion and the like) of the humidifier 10, and the opposite side is defined as a left side (a left portion and the like). The upper side in FIG. 2 is defined as an upper side (an upper portion and the like) of the humidifier 10, and the opposite side is defined as a lower side (a lower portion and the like). The lower side in FIG. 3 is defined as a front side (a front portion and the like) of the humidifier 10, and the opposite side (a side closer to the end plate 1) is defined as a rear side (a rear portion and the like). In the following description, a positional relation of each portion of the humidifier 10 is described in accordance with this definition.

As illustrated in FIG. 2 to FIG. 5, the humidifier 10 accommodates the humidification unit 11 in a case C. The case C includes a case body 12 made of resin (the case body 12 may be made of metal) and including a rear portion coupled to the end plate 1, and an outer wall 13 made of resin and covering an opening on a front side in the case body 12.

As illustrated in FIG. 1 to FIG. 5, the outer wall 13 includes a plate-shaped portion that covers the front opening of the case body 12. The outer wall 13 is formed with an intake guide 13a (one example of an intake portion), a supply guide 13b (one example of a supply portion), a reception guide 13c (one example of a reception portion), and a discharge guide 13d (one example of a discharge portion) that are associated with the plate-shaped portion in such a way as to protrude outward from the plate-shaped portion in a swelling manner.

In association with the respective guides, an intake port 13ap (one example of an inflow port), a supply port 13bp, a reception port 13cp, and a discharge port 13dp (one example of an outflow port) are formed in the outer wall 13, for the respective regions covered with the intake guide 13a, the supply guide 13b, the reception guide 13c, and the discharge guide 13d.

With this configuration, the intake guide 13a guides dry air supplied from a first flow path 21 as a dry side flow path DL, to the humidification unit 11 through the air intake port 13ap. The humidification unit 11 humidifies the dry air supplied through the intake port 13ap, and sends out the humidified air to the supply guide 13b through the supply port 13bp. The supply guide 13b sends out the humidified air to a second flow path 22 as a humidified side flow path HL.

The reception guide 13c guides the moisture-containing air supplied from a third flow path 23 as a moisture-containing side flow path WL, to the humidification unit 11 through the reception port 13cp. The humidification unit 11 extracts moisture from the moisture-containing air supplied through the reception port 13cp, and provides the moisture to the dry air, thereby humidifying the dry air, as described above. The discharge guide 13d guides, to a fourth flow path 24 as a dehumidified side flow path EL, the dehumidified air whose moisture has been extracted by the humidification unit 11 and that has been sent out from the discharge port 13dp.

Particularly, the humidifier 10 has a structure that separates, from each other inside the case body 12, the air supplied from the dry side flow path DL and the air supplied from the moisture-containing side flow path WL.

The humidifier 10 includes an intake control valve 15, a switching valve 26, and a discharge control valve 16, outside the case body 12. The intake control valve 15 and the switching valve 26 operate inner valve bodies by drive of electric actuators, and thereby switches the flow paths. The discharge control valve 16 functions as a pressure regulation valve.

### [Humidifier: Humidification Unit]

Although details are not illustrated in the drawings, the humidification unit 11 includes a plurality of plate-shaped separators and humidification membranes sandwiched by a plurality of the separators and performing humidity exchange. The separator includes a flow path that causes the dry air to flow in contact with a one-side surface of the humidification membrane and thereby produces the humidified air, and a flow path that causes the moisture-containing air to flow in contact with an opposite-side surface of the humidification membrane and thereby provides the moisture contained in the moisture-containing air to the dry air via the humidification membrane and thus produces the dehumidified air.

The humidifier 10 has a structure by which the dry air supplied from the first flow path 21 to the intake guide 13a is caused to contact with the humidification membranes of the separators of the humidification unit 11 inside the case body 12 and then flow upward. Thus, the dry air is given moisture from the separators and becomes the humidified air, and is discharged from the supply guide 13b to the second flow path 22.

The humidifier 10 has a structure by which the moisture-containing air supplied from the third flow path 23 to the reception guide 13c is caused to contact with the humidification membranes of a plurality of the separators inside the case body 12 and then flow upward. Thus, the moisture-containing air is dehumidified by the separators and becomes the dehumidified air, and is discharged from the discharge guide 13d to the fourth flow path 24.

### [Humidifier: Flow Paths]

As illustrated in FIG. 1 to FIG. 3, the humidifier 10 includes a suction port 10a, a supply port 10b, a reception port 10c, and a discharge port 10d.

The supply port 10b is connected to the suction hole 1a of the end plate 1. The reception port 10c is connected to the discharge hole 1b of the end plate 1.

As illustrated in FIG. 1, the first flow path 21 (dry side flow path DL) is formed between the suction port 10a and the intake guide 13a, and the second flow path 22 (humidified side flow path HL) is formed between the supply guide 13b and the supply port 10b.

The third flow path 23 (moisture-containing side flow path WL) is formed between the reception port 10c and the reception guide 13c, and the fourth flow path 24 (dehumidified side flow path EL) is formed between the discharge guide 13d and the discharge port 10d.

The dry air pressurized by a supply device such as a compressor is supplied to the suction port 10a. The intake control valve 15 is configured in such a way as to be switchable between a supply position of supplying the dry air flowing in the first flow path 21 to the intake guide 13a and a branch position of causing the dry air flowing in the first flow path 21 to branch into a branch flow path 21a. The branch flow path 21a merges into the second flow path 22.

With such a configuration, setting the intake control valve 15 at the supply position causes the dry air flowing in the first flow path 21 to be supplied from the intake guide 13a to the humidification unit 11 inside the humidifier 10 and to be thus humidified. Thereby, the thus-humidified air is sent out to the second flow path 22, and is supplied as a cathode gas to the fuel cells 2 from the supply port 10b.

Setting the intake control valve 15 at the branch position causes the dry air in the first flow path 21 to be sent to the supply port 10b and to be thus supplied as a cathode gas to the fuel cells 2.

The discharge control valve 16 maintains, at a set value, a pressure of the dehumidified air flowing on an upstream side of the fourth flow path 24 connected to an upstream side of the discharge control valve 16. The dehumidified gas discharged from the discharge port 10d is discharged to an outside via vehicle's muffler or the like.

As illustrated in FIG. 1 and FIG. 2, the humidifier 10 includes a bypass flow path 25 that causes the dry air sucked from the suction port 10a to flow to the discharge port 10d. The bypass flow path 25 has a cylindrical shape through which the dry air can flow, and is fixed to the outer surface of the outer wall 13.

Particularly, the bypass flow path 25 is arranged in such a way as to be fitted in a concave space 13e at a position on the outer wall 13 of the case C, on a lower side of a pair of the guides as the supply guide 13b and the discharge guide 13d on an upper side, and on an upper side of a pair of the guides as the intake guides 13a and reception guides 13c on a lower side, and is fixed to the outer wall 13 by technique such as welding or adhesion.

A start end portion 25a (upstream portion) in the bypass flow path 25 communicates with the first flow path 21 via the switching valve 26. A terminal end portion 25b (downstream portion) in the bypass flow path 25 communicates with the fourth flow path 24.

The switching valve 26 is configured in such a way as to be switchable between a communication position of supplying the dry air supplied from the suction port 10a to the intake control valve 15 via the first flow path 21 and a bypass position of supplying the dry air in the first flow path 21 to the bypass flow path 25.

With such a configuration, setting the switching valve 26 at the bypass position causes the first flow path 21 (dry side flow path DL) to be connected to the fourth flow path 24 (dehumidified side flow path EL), and thereby, the dry air flowing in the first flow path 21 is caused to flow to the fourth flow path 24, and the electric power generation in the fuel cell battery FC can be suppressed.

In a fuel cell vehicle (FCV), electric power generation needs to be promptly stopped in the fuel cell battery FC in some cases. Cutting-off of supply of air to the fuel cell battery FC is effective for stopping the electric power generation, and the suction port 10a and the discharge port 10d are caused to communicate with each other in a short-circuit manner by the bypass flow path 25 so that supply of air to the fuel cells 2 is cut off, and the electric power generation in the fuel cell battery FC can be reliably stopped.

### [Humidifier: Specific Configuration of Outer Wall and the Like]

As illustrated in FIG. 2 to FIG. 5, each of the intake guide 13a, the supply guide 13b, the reception guide 13c, and the discharge guide 13d is formed integrally with an overhang portion that overhangs outward from an outer edge of the plate-shaped portion of the outer wall 13. Further, both end portions of the bypass flow path 25 in the flow direction are integrally formed with overhang portions.

A part of the first flow path 21, a part of the second flow path 22, the third flow path 23, and a connection portion 24p of an end portion of the fourth flow path 24 are formed integrally on the outer wall portion of the case body 12. Openings of end portions of the part of the first flow path 21, the part of the second flow path 22, the third flow path 23, and the connection portion 24p of the end portion of the fourth flow path 24 are arranged at positions arrayed on the opening outer edge on a front side in the case body 12.

Thereby, fixing the outer wall 13 at a position covering the opening of the case body 12 causes the first opening 21J of the end portion of the first flow path 21 to communicate with the overhang portion of the intake guide 13a, and causes the second opening 22J of the end portion of the second flow path 22 to communicate with the overhang portion of the supply guide 13b.

Similarly to this, fixing the outer wall 13 at the position covering the opening of the case body 12 causes the third opening 23J of the end portion of the third flow path 23 to communicate with the overhang portion of the reception guide 13c, and causes the fourth opening 24J of the end portion of the connection portion 24p of the fourth flow path 24 to communicate with the overhang portion of the discharge guide 13d.

Similarly to this, a first relay portion 12p and a second relay portion 12q are formed integrally on the outer wall portion of the case body 12. The first relay portion 12p and the second relay portion 12q are arranged at positions arrayed on the outer edge of the opening on a front side in the case body 12.

Further, fixing the outer wall 13 at the position covering the opening of the case body 12 causes a first relay opening 12pJ of the first relay portion 12p to communicate with the overhang portion on an upstream side in the bypass flow path 25. Similarly to this, the second relay opening 12qJ of the second relay portion 12q communicates with the overhang portion on a downstream side in the bypass flow path 25.

As illustrated in FIG. 2 to FIG. 5, the first flow path 21 of the case body 12 is connected to a suction side of the intake control valve 15. The second flow path 22 (functioning also as the branch flow path 21a) is formed between a discharge side of the intake control valve 15 and the supply port 10b. Into this second flow path 22, the second flow path 22 connected to the supply guide 13b merges.

In the humidifier 10, the switching valve 26 is arranged near the intake control valve 15. The first flow path 21 to which the dry air is supplied from the suction port 10a is connected to the switching valve 26. The first flow path 21 that sends the dry air to the intake control valve 15 is connected to the switching valve 26. Further, the start end portion 25a of the bypass flow path 25 is connected to the switching valve 26, and a downstream side of the start end portion 25a is connected to the first relay portion 12p.

As illustrated in FIG. 2 and FIG. 4, an upstream side of the terminal end portion 25b of the bypass flow path 25 is connected to the second relay portion 12q, and a downstream end portion of the terminal end portion 25b is connected to the discharge control valve 16. The terminal end portion 25b of the bypass flow path 25 comes into communication with the fourth flow path 24, in an inner space of the discharge control valve 16.

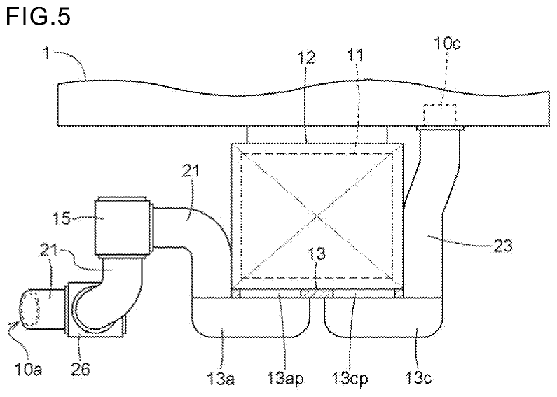

As illustrated in FIG. 2 and FIG. 5, the third flow path 23 of the case body 12 communicates with the reception port 10c. The fourth flow path 24 has a hose shape, and an upstream side of the fourth flow path 24 is connected to the connection portion 24p formed at the case body 12. A downstream side of the fourth flow path 24 is connected to the discharge control valve 16.

The intake control valve 15 and the switching valve 26 are not limited to a configuration of being arranged in a separated state, but may also be configured in such a way that the intake control valve 15 and the switching valve 26 are accommodated in a single block, in a conceivable example.

In this embodiment, each of the intake guide 13a, the supply guide 13b, the reception guide 13c, the discharge guide 13d, and the bypass flow path 25 is formed with the overhang portion, but a configuration for supplying and discharging an anode gas and an anode off-gas may be a configuration without using the overhang portions. The humidifier 10 having this configuration can also be used for humidifying an anode gas, and in a case of such use, it is also conceivable that a configuration for supplying and discharging an anode gas and an anode off-gas is a configuration without using the overhang portions.

Namely, for example, the conceivable configuration is one of connecting a flow path that corresponds to each of the intake guide 13a, the supply guide 13b, the reception guide 13c, the discharge guide 13d, and the bypass flow path 25.

### [Control Form]

Although not illustrated in the drawings, the fuel cell battery FC includes a control device that controls each of the intake control valve 15, the discharge control valve 16, and the switching valve 26. The control device acquires a signal from a sensor measuring a moisture amount inside the fuel cells 2, and a control signal indicating a travelling state of a vehicle body.

When a moisture amount acquired from the sensor is smaller than a preset threshold value, the control device sets the switching valve 26 at the communication position, and sets the intake control valve 15 at the supply position. Thereby, the humidified air humidified by the humidifier 10 is supplied to the fuel cells 2, and efficient electric power generation is enabled. A moisture amount inside the fuel cells 2 can also be acquired based on an electric power generation state of the fuel cell battery FC. For this reason, the control device may be configured in such a way as to control the intake control valve 15, based on a moisture amount acquired from an electric power generation state of the fuel cell battery FC.

Meanwhile, when the control device determines that a moisture amount acquired by the sensor or a moisture amount acquired based on an electric power generation state is larger than the preset threshold value, the control device sets the switching valve 26 at the communication position and thereby causes the dry air from the suction port 10a to flow to the first flow path 21, and operates the intake control valve 15 to the branch position. Thereby, the supply of the humidified air humidified by the humidifier 10 is stopped, the dry air that has not been humidified is supplied to the fuel cell battery FC, and a moisture amount inside the fuel cells 2 is returned to an appropriate value. The intake control valve 15 and the switching valve 26 can also be configured in such a way as to not only simply switch the flow path, but also set a supply amount of the dry air by setting an opening degree, and arbitrarily set a branching ratio of the dry air.

Based on the acquired control signal, the control device sets the switching valve 26 at the communication position, and sets the intake control valve 15 at the supply position so that the dry air can be supplied to the fuel cell FC via the humidifier 10 and the electric power generation in the fuel cell battery FC can be continued, in a case where electric power is required continuously, such as a case where the vehicle body is in a travelling state or a case where travelling of the vehicle body is temporarily stopped.

Meanwhile, when the control device determines that the travelling is stopped, or when the electric power generation needs to be stopped, the control device operates the switching valve 26 to the bypass position. Thereby, the dry air flows to the discharge port 10d via the bypass flow pass 25, the supply of the air to the fuel cells 2 is stopped, and thereby, wasteful electric power generation is suppressed.

### Advantageous Effects of Embodiment

As described above, at the time of generating electric power by the fuel cell battery FC, the control device sets the switching valve 26 at the communication position, and sets the intake control valve 15 at the supply position. With this setting, the dry air supplied to the suction port 10a is supplied from the first flow path 21 to the intake guide 13a.

The dry air supplied to the intake guide 13a is given moisture by contacting with the humidification membranes of the separators of the humidification unit 11 inside the humidifier 10, thus becomes the humidified air, and reaches the supply guide 13b. The humidified air (cathode gas) that has reached the supply guide 13b flows from the second flow path 22 to the supply port 10b, and is supplied to the fuel cells 2.

The humidified air supplied to the fuel cells 2 becomes moisture-containing air (cathode off-gas) whose oxygen in the air has been consumed accompanying the electric power generation and that has been given the generated moisture. The thus-generated moisture-containing air is supplied from the reception port 10c to the reception guide 13c via the third flow path 23.

The moisture-containing air supplied to the reception guide 13c reaches the discharge guide 13d, as dehumidified air whose moisture has been extracted by contacting with the humidification membranes of the separators of the humidification unit 11. The dehumidified air that has reached the discharge guide 13d is sent to the fourth flow path 24, is sent from the discharge control valve 16 to the discharge port 10d, and is discharged from the discharge port 10d.

As described above, when a moisture amount inside the fuel cells 2 exceeds the threshold value, the control device operates the intake control valve 15 to the branch position, and thereby causes the dry air to be supplied to the fuel cells 2. This supply causes a moisture amount in the fuel cells 2 to be promptly restored to an appropriate value.

Further, the control device operates the switching valve 26 to the bypass position in a case of stopping the electric power generation in the fuel cells 2 or in a case of switching to low-output electric power generation, as in a case where travelling of the vehicle body has been stopped. as described above. Thereby, the air flows to the discharge port 10d via the bypass flow path 25, the supply of the air to the fuel cells 2 is stopped, and wasteful electric power generation is suppressed.

The humidifier 10 includes the outer wall 13 where the intake guide 13a, the supply guide 13b, the reception guide 13c, and the discharge guide 13d are formed in such a way as to protrude. The bypass flow path 25 is fixed to the outer wall 13 in a state of being arranged in the concave space 13e at an intermediate position among these guides. Thereby, the bypass flow path 25 is prevented from protruding outward, and the maintenance becomes easier.

Thereby, a space for arrangement of piping for forming the bypass flow path 25 does not need to be secured. Further, for example, a process of connecting a conduit for connecting the bypass flow path 25 to the dry side flow path DL or a conduit for connecting the bypass flow path 25 to the fourth flow path 24 can be shortened or omitted, an increase in the number of components is not caused, and an increase in a size of the humidifier 10 can be suppressed.

### Alternative Embodiments

Differently from the above-described embodiment, this disclosure may be configured as follows (elements having the same functions as those in the embodiment are denoted by the same reference numerals and signs as those in the embodiment).

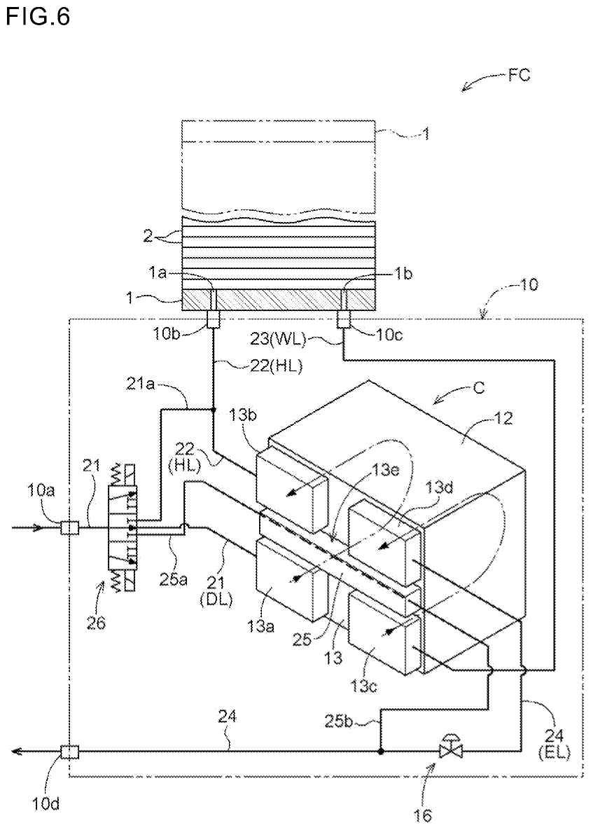

(a) A single switching valve 26 is used as illustrated in FIG. 6, without using the intake control valve 15 described in the embodiment.

The switching valve 26 is configured in such a way as to be switchable to three positions that are a neutral position, a branch position, and a bypass position. The switching valve 26 at the neutral position supplies the dry air from the suction port 10a only to the intake guide 13a. The switching valve 26 at the branch position causes the dry air from the suction port 10a to merge into the second flow path 22. The switching valve 26 at the bypass position supplies the dry air from the suction port 10a to the bypass flow path 25.

In this alternative embodiment (a), the single switching valve 26 is used to eliminate necessity of the intake control valve 15, thereby reducing the number of components. An electromagnetic valve including a spool that is switchable to the three positions, or a rotary type valve including a rotary type valve body can be used as the switching valve 26.

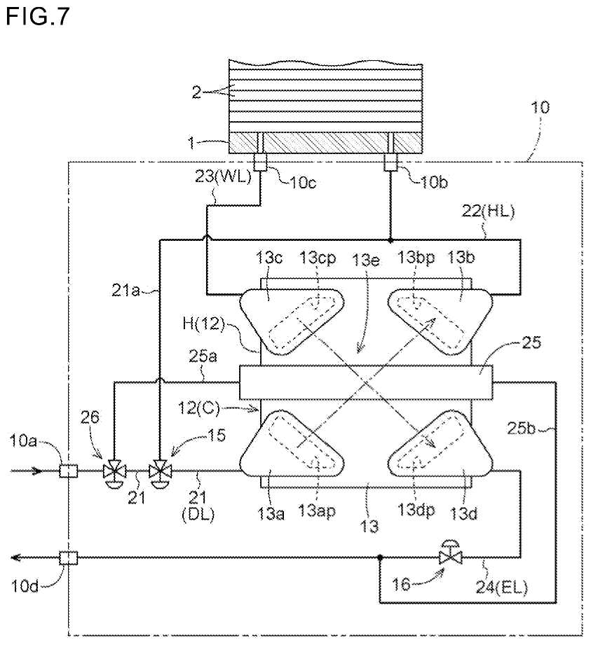

(b) As illustrated in FIG. 7, the humidifier 10 is configured in such a way that, in association with the rectangular outer wall 13, the intake guide 13a and the supply guide 13b are arranged on one diagonal line, and the reception guide 13c and the discharge guide 13d are arranged on the other diagonal line. The bypass flow path 25 is provided in association with the outer wall 13 of the humidifier 10 having such a configuration.

In this alternative embodiment (b), the intake port 13ap, the supply port 13 bp, the reception port 13cp, and the discharge port 13dp are formed at the outer wall 13 in association with a plurality of the guides. In this configuration, the dry gas supplied from the intake port 13ap flows along the diagonal line, and is sent out as the humidified air from the supply port 13 bp. Similarly to this, the moisture-containing air supplied to the intake port 13cp flows along the diagonal line, and is sent out as the dehumidified air from the discharge port 13dp.

In this alternative embodiment (b), similarly to the embodiment, the intake guide 13a, the supply guide 13b, the reception guide 13c, and the discharge guide 13d are each formed in such a way as to protrude from the plate-shaped portion of the outer wall 13 in a manner of swelling to a front side.

In this alternative embodiment (b), an inside structure of the case body 12 of the humidifier 10 is partially different from that of the humidifier 10 in the embodiment, but the concave space 13e is formed on a lower side of a pair of the guides as the upper-side reception guides 13c and supply guides 13b and on an upper side of a pair of the guides as the lower-side intake guide 13a and discharge guide 13d. The bypass flow path 25 is provided in the concave space 13e.

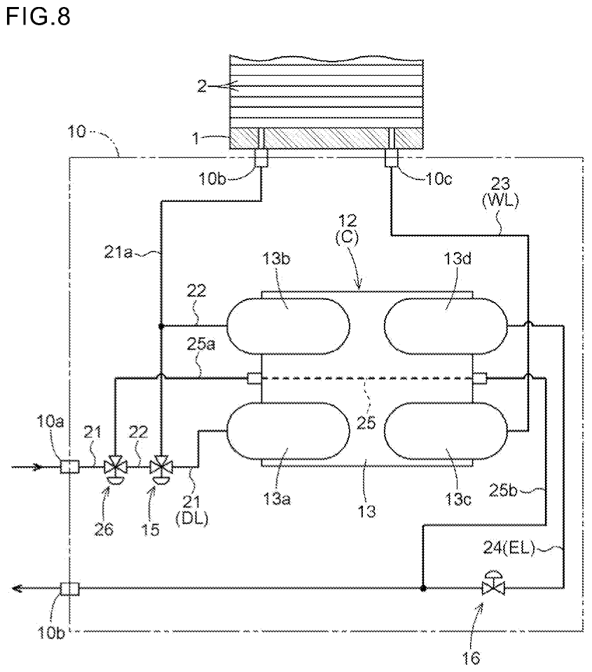

(c) As illustrated in FIG. 8, the bypass flow path 25 is provided inside the case body 12 of the humidifier 10. This alternative embodiment (c) has a flow path configuration common to that described in the embodiment, and differs from the embodiment in that the bypass flow path 25 is formed inside the case body 12.

Forming the bypass flow path 25 inside the case body 12 in such a manner can reduce the number of the protrusions on the outer surface of the humidifier 10, as compared with a configuration in which the bypass flow path 25 is provided outside the humidifier 10.

In an alternative embodiment of this alternative embodiment (c), it can be conceivable that the bypass flow path 25 is provided in an inner space of the case body 12 of the humidifier 10 having the configuration similar to that of the alternative embodiment (b).

(d) The bypass flow path 25 is not limited to being formed linearly, but may be in an arc shape or a bent shape, and even when the bypass flow path 25 is formed linearly, the bypass flow path 25 can be set in an inclined posture.

(e) The bypass flow path 25 may be provided on an upper surface or a lower surface of the case body 12 of the humidifier 10, or may be partially arranged inside the case body 12.

The configuration disclosed in each of the above-described embodiments (including the alternative embodiments, which applies to the following) can be applied in combination with the configuration disclosed in another of the embodiments, as long as there is no contradiction, and the embodiments disclosed in this specification are illustrative, and the embodiments of this disclosure are not limited to these, and can be modified appropriately within a range that does not deviate from the purpose of this disclosure.

### INDUSTRIAL APPLICABILITY

This disclosure can be used in the humidifier that humidifies air to be supplied to a cathode side in a fuel cell battery.

A humidifier according to an aspect of this disclosure includes a humidification unit, a dry side flow path, a dehumidified side flow path, a case, a bypass flow path, and a switching valve. The humidification unit provides, for dry air to be supplied to a fuel cell battery, moisture of moisture-containing air sent out from the fuel cell battery. The dry side flow path is connected to the humidification unit. The dry air flows through the dry side flow path. The dehumidified side flow path is connected to the humidification unit. Dehumidified air generated by dehumidifying the moisture-containing air by the humidification unit flows through the dehumidified side flow path. The case accommodates the humidification unit, and includes an inflow port into which the dry air flows and an outflow port from which the dehumidified air flows out. The bypass flow path connects the dry side flow path to the dehumidified side flow path. The switching valve can switch the dry air flowing through the dry side flow path, to one of the humidification unit and the bypass flow path. A part of the bypass flow path is provided at the case.

According to this configuration, controlling the switching valve enables the dry air to be supplied to one of the inflow port and the bypass flow path. Supplying the dry air to the bypass flow path can stop supply of the dry air to the fuel cell battery, thereby enabling prompt stop of electric power generation in the fuel cell battery. Particularly, a part of the bypass flow path is provided at the case that accommodates the humidification unit, and thus, a space for arranging the bypass flow path does not need to be secured, and for example, a process of forming a conduit for connecting the bypass flow path to the dry side flow path or a conduit for connecting the bypass flow path to the dehumidified side flow path can be shortened, and a size increase is not caused. According to the thus-configured humidifier, the number of components can be reduced, and routing of the piping can be improved, regarding the bypass flow path for stopping supply of air to the fuel cell battery

The case may include a case body and an outer wall. The case body is supported by an end plate of the fuel cell battery, and accommodates the humidification unit. The outer wall is included in the case body, and is arranged on an opposite side of the end plate. The bypass flow path may be provided on an outer surface of the outer wall.

According to this configuration, for example, the bypass flow path can be supported in a state of being welded on the outer surface of the outer wall, or the bypass flow path can be formed integrally with the outer wall. With this configuration, the bypass flow path is exposed, and thus, maintenance can be easily performed.

An intake portion, a supply portion, a reception portion, and a discharge portion may be formed at the outer wall in such a way as to protrude outward. The intake portion is provided between the inflow port and the dry side flow path, and sends the dry air to the humidification unit. The supply portion supplies, to the fuel cell battery, humidified air generated by the humidification unit humidifying the dry air sent from the intake portion. The reception portion receives the moisture-containing air sent out from the fuel cell battery, and sends the received moisture-containing air to the humidification unit. The discharge portion discharges, to the dehumidified side flow path, the dehumidified air generated by the humidification unit extracting moisture of the moisture-containing air sent from the reception portion. The bypass flow path may be arranged in a concave space surrounded by the intake portion, the supply portion, the reception portion, and the discharge portion.

According to this configuration, the bypass flow path is arranged in the concave space surrounded by any of the intake portion, the supply portion, the reception portion, and the discharge portion, and thus, the bypass flow path does not largely protrude to the outer surface of the outer wall, and a size increase of the humidifier is not caused.

An intake control valve may be provided on a downstream side of the switching valve. The intake control valve is able to select one of the humidification unit and the fuel cell battery and supply the dry air to the selected humidification unit or fuel cell battery.

According to this configuration, for example, when excessive moisture exists inside the fuel cell battery, controlling the intake control valve causes sucked dry air from a suction port to be supplied to the fuel cell battery, thereby enabling the moisture inside the fuel cell battery to be reduced. Controlling the switching valve also enables sucked dry air from the suction port to flow to the bypass flow path. Particularly, the switching valve is arranged on an upstream side of the intake control valve, and thus, the dry air can be reliably cut off to the fuel cell battery, regardless of a setting of the intake control valve.

The switching valve may be configured in such a way as to be able to select one of the humidification unit, the fuel cell battery, and the bypass flow path and switch the dry air flowing in the dry side flow path, to the selected humidification unit, fuel cell battery, or bypass flow path.

According to this configuration, controlling the switching valve enables dry air from the suction port to be supplied to one of the fuel cell battery, the humidification unit, and the bypass flow path. In other words, one of the three flow paths is selected by the single switching valve, and dry air is supplied to the selected flow path, and thus, a plurality of valves do not need to be used, and the number of components can be reduced.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A humidifier comprising:
a humidification unit that provides, for dry air to be supplied to a fuel cell battery, moisture of moisture-containing air sent out from the fuel cell battery;
a dry side flow path that is connected to the humidification unit and through which the dry air flows;
a dehumidified side flow path that is connected to the humidification unit and through which dehumidified air flows, the dehumidified air being generated by dehumidifying the moisture-containing air by the humidification unit;
a case that accommodates the humidification unit and includes an inflow port into which the dry air flows and an outflow port from which the dehumidified air flows out;
a bypass flow path that connects the dry side flow path to the dehumidified side flow path; and
a switching valve that can switch the dry air flowing through the dry side flow path, to one of the humidification unit and the bypass flow path, wherein
a part of the bypass flow path is provided at the case.

2. The humidifier according to claim 1, wherein
the case includes: a case body that is supported by an end plate of the fuel cell battery and accommodates the humidification unit; and an outer wall that is included in the case body and that is arranged on an opposite side of the end plate, and
the bypass flow path is provided on an outer surface of the outer wall.

3. The humidifier according to claim 2, wherein
an intake portion, a supply portion, a reception portion, and a discharge portion are formed at the outer wall in such a way as to protrude outward, the intake portion being provided between the inflow port and the dry side flow path and sending the dry air to the humidification unit, the supply portion supplying, to the fuel cell battery, humidified air generated by the humidification unit humidifying the dry air sent from the intake portion, the reception portion receiving the moisture-containing air sent out from the fuel cell battery and sending the received moisture-containing air to the humidification unit, the discharge portion discharging, to the dehumidified side flow path, the dehumidified air generated by the humidification unit extracting moisture of the moisture-containing air sent from the reception portion, and
the bypass flow path is arranged in a concave space surrounded by the intake portion, the supply portion, the reception portion, and the discharge portion.

4. The humidifier according to claim 1, wherein
an intake control valve is provided on a downstream side of the switching valve, the intake control valve being able to select one of the humidification unit and the fuel cell battery and supply the dry air to the selected humidification unit or fuel cell battery.

5. The humidifier according to claim 2, wherein
an intake control valve is provided on a downstream side of the switching valve, the intake control valve being able to select one of the humidification unit and the fuel cell battery and supply the dry air to the selected humidification unit or fuel cell battery.

6. The humidifier according to claim 1, wherein
the switching valve is configured in such a way as to be able to select one of the humidification unit, the fuel cell battery, and the bypass flow path and switch the dry air flowing in the dry side flow path, to the selected humidification unit, fuel cell battery, or bypass flow path.

7. The humidifier according to claim 2, wherein
the switching valve is configured in such a way as to be able to select one of the humidification unit, the fuel cell battery, and the bypass flow path and switch the dry air flowing in the dry side flow path, to the selected humidification unit, fuel cell battery, or bypass flow path.
